(19) United States
(12) Patent Application Publication
(10) Pub. No.: US 2010/0252722 A1
(43) Pub. Date: Oct. 7, 2010

(54) Optical encoder assembly including collimating reflective surface features

(76) Inventors: Robert Procsal, Richardson, TX (US); Trevor Schelp, McKinney, TX (US); Tom Couch, Sunnyvale, CA (US)

Correspondence Address: KRIEG DEVAULT LLP, ONE INDIANA SQUARE, SUITE 2800, INDIANAPOLIS, IN, 46204-2079, US

(21) Appl. No.: 12/657,737

(22) Filed: Jan. 27, 2010

Related U.S. Application Data
(60) Provisional application No. 61/206,063, filed on Jan. 27, 2009.

(51) Int. Cl. G01D 5/347

(52) U.S. Cl. 250/231.14

(57) ABSTRACT

An optical encoder assembly including at least one light source or emitter element, at least one light detector or sensor element, at least one code member including a plurality of code elements arranged along a track extending along a plane with the emitter element and the sensor element positioned on a first side of the plane, and a reflector element positioned on an opposite second side of the plane and including a reflective surface having one or more collimating reflective surface features that reflect light emitted from the emitter element to the code element and on to the sensor element.

### CROSS REFERENCE TO RELATED APPLICATIONS

The present application claims the benefit of U.S. Provisional Application No. 61/206,063 filed on Jan. 27, 2009, the contents of which are hereby incorporated by reference in their entirety.

### FIELD OF THE INVENTION

The present invention relates generally to the field of optical encoders, and more particularly, but not exclusively, relates to optical encoders including collimating reflective surface features.

### BACKGROUND

Optical encoders are used to measure position and/or motion (i.e., rate and/or direction of displacement) of a moveable object. Optical encoders typically fall within one of two general categories; namely, linear encoders and rotary encoders. Linear encoders are configured to provide an indication of linear position and/or motion, whereas rotary encoders are configured to provide an indication of rotational position and/or motion. Additionally, although optical encoders may take many forms, most can be characterized as either transmissive-type or reflective-type.

Referring to FIG. 1, shown therein is a schematic representation of a conventional transmissive-type optical encoder 10. The optical encoder 10 generally includes a light source 12, a light sensor or photodetector 14, and a code member 16 including a plurality of apertures or slits 18. The code member 16 is coupled to a movable object (not shown), such that rotational or linear movement of the movable object results in corresponding rotational or linear movement of the code member 16 along arrows M. In the case of rotary encoders, the code member 16 is sometimes referred to as an encoder wheel, with the apertures 18 positioned along one or more circumferential tracks or scales extending about an axis of rotation. In the case of linear encoders, the code member 16 is sometimes referred to as an encoder strip, with the apertures 18 positioned along one or more linear tracks or scales extending along a linear axis of travel. The light source 12 and the light sensor 14 are positioned on opposite sides of the code member 16 and are generally aligned with one another along a light transmission axis L that is positioned in general alignment with the aperture tracks. As the code member 16 is displaced by a movable component along arrows M, when one of the apertures 18_{A} is generally aligned with the light transmission axis L, the light source 12 transmits beams of light B through the aligned aperture 18_{A}, which is in turn detected by the light sensor 14. As should be appreciated, the apertures 18 may be provided in a particular pattern to produce a varying light pattern that is detected by the light sensor 14 and which corresponds to the position and/or motion of the movable object.

Referring to FIG. 2, shown therein is a schematic representation of a conventional reflective-type optical encoder 20. The optical encoder 20 generally includes a light source 22, a light sensor 24, and a code member 26 including a plurality of reflector elements 28. Once again, the code member 26 is coupled to a movable object such that rotational or linear movement of the object results in corresponding rotational or linear movement of the code member 26 along arrows M. The light source 22 and the light sensor 24 are positioned on the same side of the code member 26 and are laterally offset from one another, with the light source 22 arranged to emit beams of light B along a light transmission axis L_{I}. As the code member 26 is displaced by a movable component along arrows M, when one of the reflector elements 28_{A} is generally aligned with the light transmission axis L₁, the beams of light B emitted from the light source 22 are reflected off of the reflector elements 28_{A} along a light transmission axis L₂, with the reflected beam of light detected by the light sensor 24. As should be appreciated, the reflector elements 28 may be provided in a particular pattern to produce a varying light pattern that is detected by the light sensor 24 and which corresponds to the position and/or motion of the movable object.

There remains a need for an improved optical encoder assembly. The present invention satisfies this need and provides other benefits and advantages in a novel and unobvious manner.

### SUMMARY

The present invention is directed to an optical encoder assembly including at least one light source or emitter element, at least one light detector or sensor element, at least one code member including a plurality of code elements arranged along a track extending along a plane with the emitter element and the sensor element positioned on a first side of the plane, and a reflector element positioned on an opposite second side of the plane and including a reflective surface having one or more collimating reflective surface features that reflect light emitted from the emitter element to the code element and on to the sensor element.

It is one object of the present invention to provide an improved optical encoder assembly including collimating reflective surface features. Further objects, features, advantages, benefits, and aspects of the present invention will become apparent from the drawings and descriptions contained herein.

### BRIEF DESCRIPTION OF THE DRAWINGS

FIG. 1 is a schematic representation of a prior transmissive-type optical encoder assembly.

FIG. 2 is a schematic representation of a prior reflective-type optical encoder assembly.

FIG. 3 is an exploded perspective view of an optical encoder assembly according to one form of the present invention.

FIG. 4 is an opposite exploded perspective view of the optical encoder assembly illustrated in FIG. 3.

FIG. 5 is a plan view of a portion of the optical encoder assembly illustrated in FIGS. 3 and 4 showing the position of a light emitter element and light sensor elements relative to the code tracks of an encoder wheel.

FIG. 6 is a side view of a portion of the optical encoder assembly illustrated in FIGS. 3 and 4, as shown in partial cross-section and including a schematic illustration of the transmission of light from the light emitter element to the light sensor elements.

FIG. 7 is an exploded perspective view of an optical encoder assembly according to another form of the present invention.

FIG. 8 is a perspective view of an optical encoder assembly according to yet another form of the present invention.

FIG. 9 is an opposite perspective view of the optical encoder assembly illustrated in FIG. 8.

FIG. 10 is an exploded perspective view of the optical encoder assembly illustrated in FIGS. 8 and 9.

FIG. 11 is a side view of an encoder housing cap and shaft assembly for use in association with the optical encoder assembly illustrated in FIGS. 8-10.

FIG. 12 is a side cross-sectional view of the encoder housing cap and shaft assembly illustrated in FIG. 11, as taken along line 12-12 of FIG. 11.

FIG. 13 is a cross-section side view of the encoder housing cap illustrated in FIGS. 11 and 12.

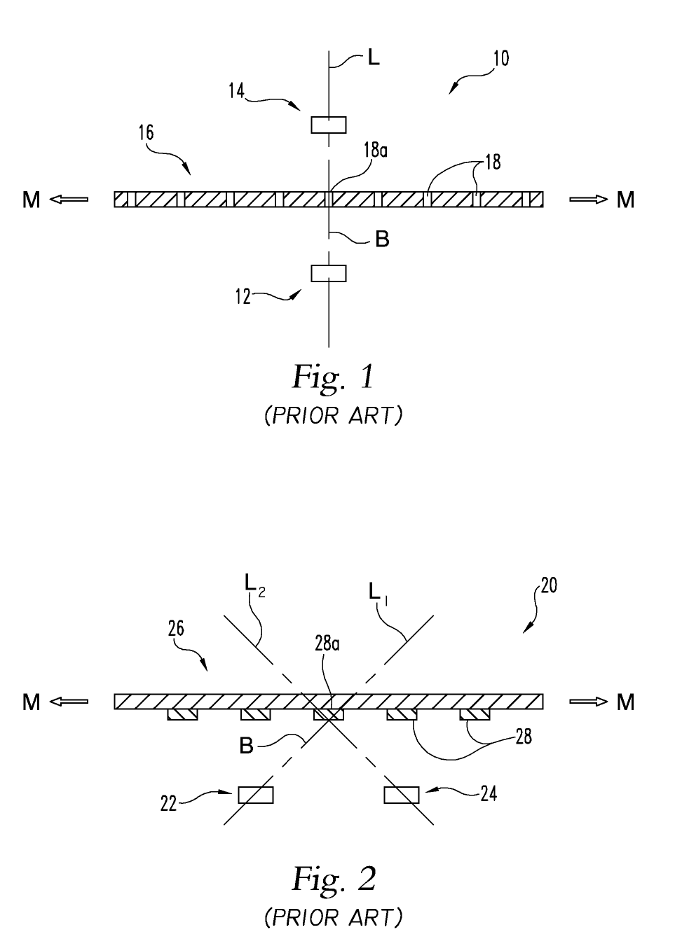

### DESCRIPTION OF EMBODIMENTS OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is hereby intended, and that alterations and further modifications to the illustrated devices and/or further applications of the principles of the invention as illustrated herein are contemplated as would normally occur to one skilled in the art to which the invention relates.

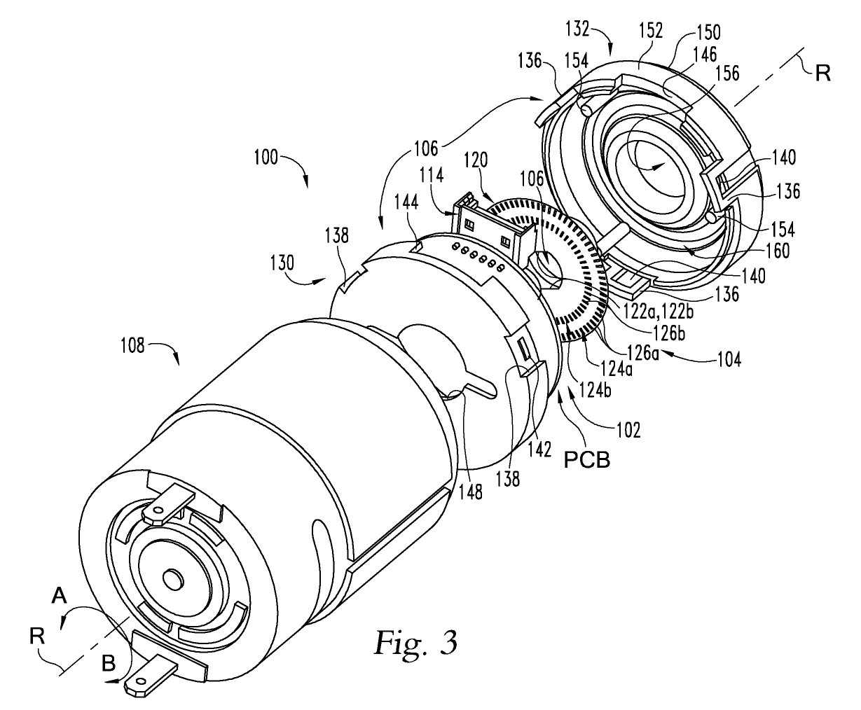

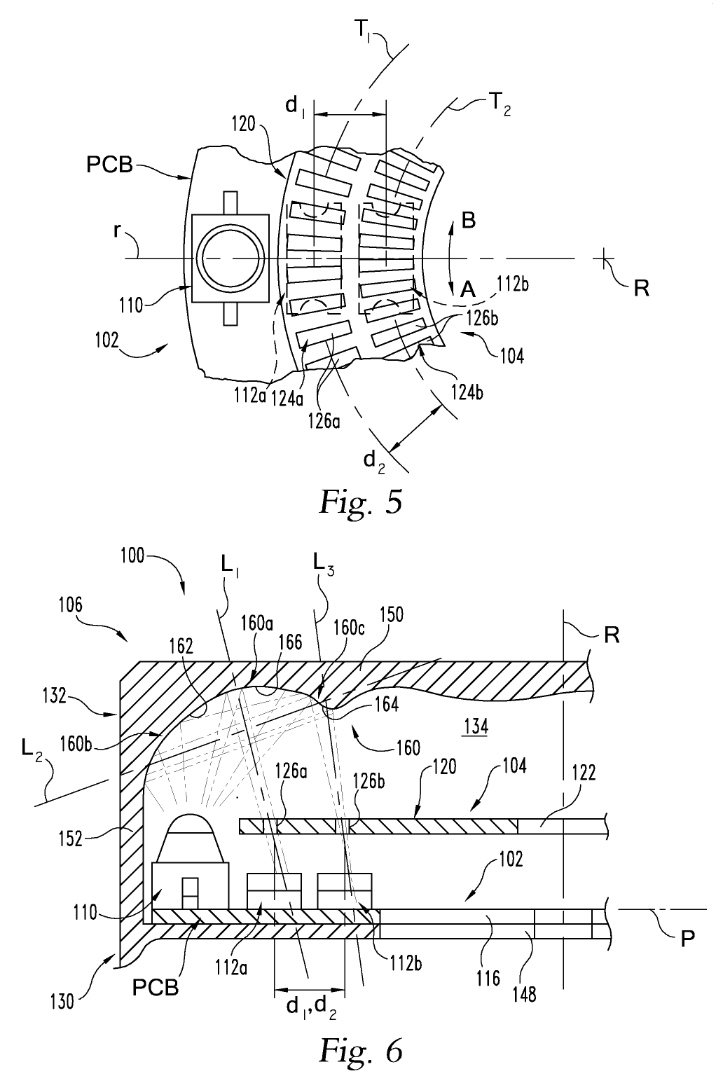

Referring to FIGS. 3-6, shown therein is an optical encoder assembly 100 according to one form of the present invention. The optical encoder assembly 100 generally includes a board member 102 having various electronic elements mounted thereto, a code mechanism or scale member 104, and an encoder housing or enclosure 106. The optical encoder assembly 100 is configured to sense relative position and/or relative movement (i.e., speed/rate and/or direction) of a movable object. In the illustrated embodiment, the optical encoder assembly 100 is a rotational encoder configured to sense the rotational position and/or rotational movement of a control shaft or rod (not shown) about a rotational axis R. However, it should be understood that the optical encoder assembly 100 may alternatively be configured as a linear encoder assembly configured to sense linear position and/or linear movement of a movable object along a linear travel axis.

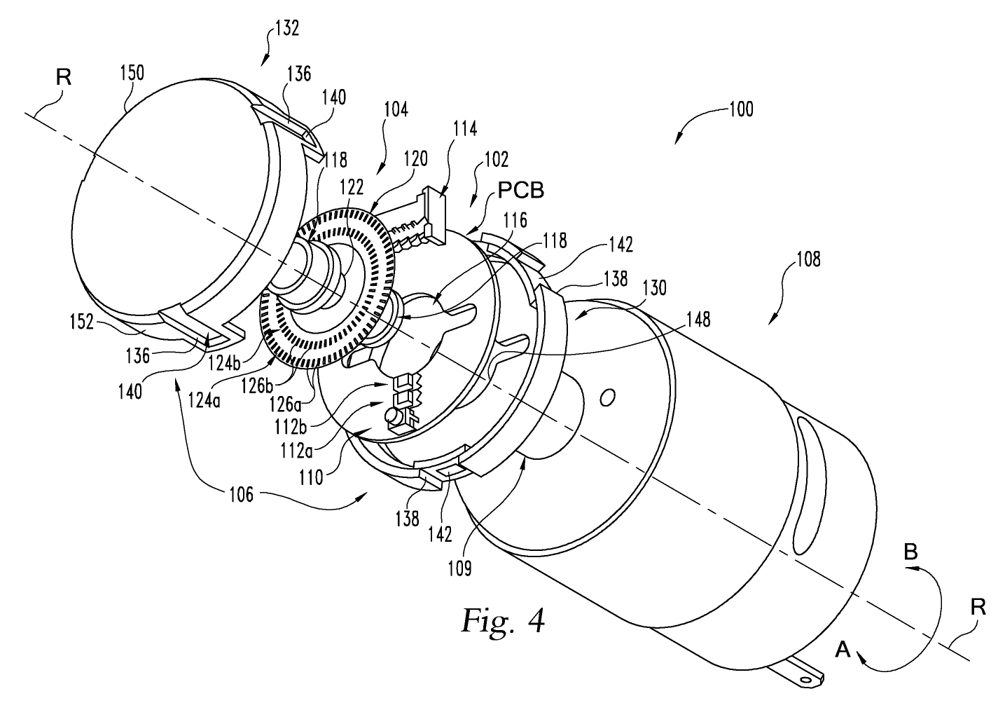

In one embodiment, the control shaft (not shown) is connected to a rotational connector or coupling element 108 such that rotation of the control shaft correspondingly rotates a stem or rod 109 (FIG. 4) associated with the coupling element 108 about the rotational axis R. The stem/rod 109 is in turn coupled to the code mechanism 104 to correspondingly rotate the code mechanism 104 about the rotational axis R in response to rotation of the control shaft and the stem/rod 109. In other embodiments, the control shaft may be connected directly to the code mechanism 104. Additionally, in the illustrated embodiment, the optical encoder assembly 100 is configured as a transmissive-type optical encoder configured to transmit beams of light through a series of apertures or slits positioned along one or more code tracks associated with the encoder wheel 104. The beams of light transmitted thorough the apertures or slits are in turn detected by one or more light sensors to provide an indication of the relative rotational position and/or relative movement of the control shaft. However, it should be understood that the optical encoder assembly 100 may alternatively be configured as a reflective-type optical encoder configured to reflect light off of a series of reflector elements positioned along one or more code tracks associated with the code mechanism 104, with the reflected light in turn detected by one or more light sensors.

In the illustrated embodiment, the board member 102 comprises a printed circuit board (PCB) and includes at least one light source or emitter element 110 and one or more photodetectors or light sensor elements 112a, 112b mounted thereto. In one embodiment, light emitter element 110 is a light emitting diode (LED) that is mounted to an outer region of the circuit board. However, it should be understood that other types of light sources or emitter elements are also contemplated, and that the light source or emitter element 110 may be mounted to other regions of the circuit board. The light sensor elements 112a, 112b are mounted to the circuit board at a location radially inward from the light emitter element 110, with the centers of the light sensor elements 112a, 112b being offset from one another by a radial distance d₁, the purpose of which will be discussed below. In the illustrated embodiment, the light emitter element 110 and the light sensor elements 112a, 112b are generally located along a common radial axis r extending perpendicularly from the rotational axis R. However, alternatively positions and locations of the light emitter element 110 and the light sensor elements 112a, 112b are also contemplated.

In a further embodiment, the board member 102 is provided with an electrical connector 114 including a series of electrical terminals that are in electronic communication with the emitter element 110 and the light sensor elements 112a, 112b via traces or leads (not shown) integrated onto the circuit board. As should be appreciated, the electrical connector 114 may be used to facilitate electronic coupling with a cable connector or wire harness (not shown) to transmit power and electronic input/output signals between the emitter and sensor elements and other electronic equipment (not shown) positioned at a location remote from the optical encoder assembly 100. Additionally, the board member 102 is provided with a central opening 116 arranged generally along the rotational axis R and sized to receive a portion of a rotational coupling sleeve 118 therethrough, which is in turn operatively connected between the code mechanism 104 and the stem/rod 109 of the coupling element 108. Although a specific embodiment of the board member 102 has been illustrated and described herein, it should be understood that other types and configurations of the board member 102 are also contemplated. It should also be understood that although the board member 102 is illustrated as including a single light source or emitter element 110 and two light sensor elements 112a, 112b, other embodiments are also contemplated which include two or more light source elements and/or a single light sensor element or three or more light sensor elements.

In the illustrated embodiment, the code mechanism 104 is configured as an encoder wheel 120 which is rotationally connected to the stem/rod 109 of the coupling element 108 via the coupling sleeve 118 such that rotation of the stem/rod 109 about the rotational axis R correspondingly rotates the encoder wheel 120 about the rotational axis R. In one embodiment, the encoder wheel 120 includes a central opening 122 arranged generally along the rotational axis R and having an irregular shape which is sized and configured to receive a correspondingly-shaped portion of the coupling sleeve 118. In one embodiment, the central opening 122 is generally circular but includes flattened regions 122a, 122b which are engaged with outer flattened regions of the coupling sleeve 118. However, other techniques for coupling the encoder wheel 120 to the coupling sleeve 118 are also contemplated as would occur to one of ordinary skill in the art.

In the illustrated embodiment, the encoder wheel 120 includes one or more code tracks or scales 124 extending circumferentially about the axis of rotation R and along a circumferential track or axis of travel T, and including a series of apertures or slits 126 positioned along the circumferential track or axis of travel T. In the illustrated embodiment, the encoder wheel 120 includes two code tracks or scales 124a, 124b extending circumferentially about the axis of rotation R and along circumferential tracks or axes of travel T₁, T₂. However, in alternative embodiments, the encoder wheel 120 may be provided with a single code track or three or more code tracks. The code tracks 124a, 124b and the axes of travel T₁, T₂ are radially offset from one another by a radial distance d₂ which is generally equal to the radial distance d₁ between the light sensor elements 112a, 112b. In this manner, the code tracks 124a, 124b may be generally aligned with the light sensor elements 112a, 112b. As should be appreciated, the code tracks 124a, 124b respectively include a series of apertures or slits 126a, 126b having select sizes/shapes and which are positioned along the code tracks at select circumferential positions, the details of which would be apparent to one of ordinary skill in the art and therefore need not be discussed in detail herein. In the illustrated embodiment, the optical encoder assembly 100 includes a single encoder wheel 120. However, in other embodiments, the optical encoder assembly 100 may be provided with two or more encoder wheels and/or may include one or more stationary reference plates or light masking elements, the details of which would also be apparent to one of ordinary skill in the art.

In the illustrated embodiment, the encoder housing or enclosure 106 is configured as a two-piece housing including a housing base 130 and a housing cap 132. The housing cap 132 is operatively connected to the housing base 130 to provide an enclosed interior region 134 (FIG. 6) sized to receive the board member 102 and the code mechanism 104 therein. In one embodiment, the housing cap 132 is attached to the housing base 130 via a number of elastically resilient clips or tongues 136 extending axially from the housing cap 132 and which are received within a corresponding number of radially recessed regions or grooves 138 defined by the housing base 130. The clips 136 each define a radial opening 140 that is sized to receive a radial projection 142 extending outwardly from each of the recessed regions 138 in the housing base 130 to removably secure the housing cap 132 to the housing base 130. However, other methods and techniques for securing the housing cap 132 to the housing base 130 are also contemplated as would occur to one of ordinary skill in the art. The housing base 130 and the housing cap 132 also define channels or axially recessed regions 144, 146 (FIG. 3) that are aligned with one another to define a transverse opening sized and shaped to receive the electrical connector 114 of the board member 102 therethrough to position the electrical connector 114 outside of the encoder housing 106. The housing base 130 further defines a central opening 148 that is sized to receive a portion of the rotational coupling sleeve 118 therethrough.

In the illustrated embodiment, the housing cap 132 generally includes a substantially planar end wall 150 and a generally cylindrical side wall 152 extending axially from the end wall 150 toward the housing base 130. The end wall 150 and the cylindrical side wall 152 together define the interior region 134 of the encoder housing 106. As indicated above, the interior region 134 is sized and shaped to receive the board member 102 and the code mechanism 104 therein. Referring specifically to FIG. 3, the housing cap 132 may include a number of interior mounting posts or pegs 154 configured to properly locate the board member 102 relative to the rotational axis R. Additionally, the housing cap 132 includes an axial recess 156 formed in the end wall 150 and positioned generally along the rotational axis R for receipt of sealed bearing and/or an end portion of the coupling sleeve 118 to rotationally couple the coupling sleeve 118 to the housing cap 132 and to maintain the coupling sleeve 118 and the code mechanism 104 in proper alignment relative to the rotational axis R.

Referring to FIG. 6, the end wall 150 and the side wall 152 of the housing cap 132 have inner surfaces that define collimating reflective surface features 160 which are shaped and configured to reflect light generated by and emitted from the emitter element 110 toward the sensor elements 112a, 112b, the details of which will be discussed below. In the illustrated embodiment, the collimating reflective surface features 160 are formed integral with the housing cap 132. However, in other embodiments, the collimating reflective surface features 160 may be defined by an insert or a secondary element formed separately from the housing cap 132 and subsequently attached to or assembled with the housing cap 132 by any technique that would occur to one of ordinary skill in the art.

In the illustrated embodiment, the collimating reflective surface features 160 include a series of generally flat/planar surface features, convex surface features, and/or concave surface features that cooperate with one another to provide an overall reflective surface profile extending along the end wall 150 and the side wall 152 of the housing cap 132. The collimating reflective surface features 160 may define a plurality of reflective surface regions that reflect and direct beams of light to particular portions or regions of the optical encoder assembly 100. For example, in the illustrated embodiment, the collimating reflective surface features 160 generally include a first reflective surface region 160a that is configured to reflect, direct and concentrate light emitted from the emitter element 110 generally along and substantially parallel with a first light transmission axis or path L₁ that is generally aligned with the outer sensor element 112a. Additionally, the collimating reflective surface features 160 include a second reflective surface region 160b that is configured to reflect, direct and concentrate light emitted from the emitter element 110 generally along and substantially parallel with a second light transmission axis or path L₂ that is generally aligned with a third reflective surface region 160c. The third reflective surface region 160c is in turn configured to reflect, direct and concentrate the light reflected from the second reflective surface region 160b generally along and substantially parallel with a third light transmission axis or path L₃ that is generally aligned with the inner sensor element 112b. As should be apparent, the collimating reflective surface features 160 may be configured to reflect, direct and concentrate light from the emitter element 110, through the interior region 134 of the encoder housing 106, and to either or both of the sensor elements 112a, 112b via a single optical reflection or via multiple optical reflections. In the illustrated embodiment, the housing cap 132 is generally provided with three reflective surface regions 160a, 160b and 160c. However, it should be understood that the housing cap 132 may be configured to define any number of reflective surface regions.

In the illustrated embodiment, the second reflective surface region 160b is defined by an angled transition or chamfered surface 162 extending between the side wall 152 and the end wall 150 and arranged at an angle of approximately 45 degrees relative to the rotational axis R. The third reflective surface region 160c is defined by an inwardly protruding surface or lip 164 extending axially from the end wall 150 and into the interior region 134 of the encoder housing 106. The first reflective surface region 160a is defined by an intermediate surface 166 extending between the angled transition surface 162 and the inwardly protruding surface or lip 164. As should be appreciated, the particular geometric configuration and surface profile of the collimating reflective surface features 160 may be varied to reflect, direct and concentrate light in multiple directions and along multiple axes to accommodate for the particular configuration and setup of the optical encoder assembly. It should be further appreciated that the collimating reflective surface features 160 will vary depending on the particular configuration and application of the optical encoder assembly, and that the particular collimating reflective surface features 160 illustrated and described in FIG. 6 constitute merely one example of a geometric configuration and surface profile that may be used in association with the optical encoder assembly 100 or other optical encoder assemblies.

As indicated above, the collimating reflective surface features 160 may be formed integral with the housing cap 132, or may be defined by an insert or a secondary element separately from the housing cap 132 and subsequently attached to or assembled with the housing cap 132 via any technique or method that would occur to one of ordinary skill in the art. In one embodiment, the inner surfaces of the end wall 150 and the side wall 152 of the housing cap 132 are machined and finely polished to provide the collimating reflective surface features 160. In another embodiment, the inner surfaces of the end wall 150 and the side wall 152 are machined and coated with a reflective material to provide the collimating reflective surface features 160. In a further embodiment, one or more lenses, mirrors or other reflective elements may be attached to the end wall 150 and/or the side wall 152 of the housing cap 132 to provide the collimating reflective surface features 160. It should be understood that other methods and techniques that would occur to one of ordinary skill in the art may be utilized to provide the collimating reflective surface features 160. Additionally, it should further be understood that the housing cap 132 may be formed of a variety of materials including but not limited to metallic materials such as stainless steel or aluminum, polymeric or plastic materials, ceramic materials, or any other suitable material that would occur to one of ordinary skill in the art. In instances where the housing cap 132 is formed of a polymeric or plastic material, it may be possible to form the housing cap 132 and the collimating reflective surface features 160 via a molding technique wherein machining of the housing cap 132 may be minimized.

Having described the structure elements and features associated with the optical encoder assembly 100, reference will now be made to operation of the optical encoder assembly 100 according to one form of the present invention. As indicated above, the optical encoder assembly 100 is illustrated as a rotational encoder configured to sense the rotational position and/or rotational movement of a control shaft (not shown) about a rotational axis R. The control shaft is connected to the rotational coupling element 108 such that rotation of the control shaft in the direction of arrows A/B correspondingly rotates the stem/rod 109 which is coupled to the encoder wheel 120 via the coupling sleeve 118. Accordingly, rotation of the control shaft in the direction of arrows A/B correspondingly rotates the encoder wheel 120 about the rotational axis R in the direction of arrows A/B. In the illustrated embodiment, the board member 102 and the encoder housing 106 are maintained in a stationary position relative to the encoder wheel 120. However, alternative embodiments are also contemplated wherein the board member 102 may be coupled to the control shaft such that rotation of the control shaft in the direction of arrows A/B correspondingly rotates the board member 102 and/or the encoder housing 106 about the rotational axis R, with the encoder wheel 120 maintained in a stationary position.

As shown most clearly in FIG. 6, the emitter element 110 and the light sensor elements 112a, 112b are arranged generally along a common plane P extending along the printed circuit board PCB and are positioned on the same side of the encoder wheel 120. As should be appreciated, the ability to position the emitter element 110 and the light sensor elements 112a, 112b on the same side of the encoder wheel 120 tends to reduce the overall height profile of the optical encoder assembly 100. The emitter element 110 is positioned radially beyond the outer circumference of the encoder wheel 120 such that the encoder wheel 120 does not interfere with or block the light generated and emitted from the emitter element 110. The light emitted from the emitter element 110 is directed onto the collimating reflective surface features 160 defined by the inner reflective surfaces of the housing cap 152, which in turn reflects, directs and concentrates the light generally along and substantially parallel with a light transmission axis L₁ that is generally aligned with the outer sensor element 112a and a light transmission axis L₃ that is generally aligned with the inner sensor element 112b.

As the encoder wheel 120 is rotated about the rotational axis R in response to rotation of the control shaft in the direction of arrows A/B, one of the apertures or slits 126_{A} associated with the outer code track 124a is positioned in general alignment with the light transmission axis L₁. As a result, light is permitted to pass through the aligned aperture or slit 126_{A} and onto the outer sensor element 112a. Similarly, during rotation of the control shaft in the direction of arrows A/B, one of the apertures or slits 126_{B} associated with the inner code track 124b is positioned in general alignment with the light transmission axis L₃. As a result, light is permitted to pass through the aligned aperture or slit 126_{B} and onto the inner sensor element 112b. As would be appreciated by one of ordinary skill in the art, the apertures or slits 126a, 126b are provided in a particular code pattern (i.e., with predetermined sizes and shapes and/or at predetermined circumferential positions) along the code tracks 124a, 124b such that detection of the light passing through the apertures or slits 126a, 126b by the inner and outer sensor elements 112a, 112b may be utilized to determine the instant rotational position and/or the rate or direction of movement of the control shaft. As indicated above, the optical encoder assembly 100 may alternatively be provided with any number of encoder wheels, including one encoder wheel or three or more encoder wheels, that define a single code track or three or more code tracks, and a board member having a single light sensor element or three or more light sensor elements.

As should be appreciated, the optical encoder assembly 100 provides various benefits and advantages over conventional optical encoder assemblies including, for example, decreased complexity in the manufacture and assembly of the optical encoder assembly, a reduction in manufacturing and assembly costs associated with the optical encoder assembly, and a reduction in the overall height profile of the optical encoder assembly. However, other benefits and advantages may also be realized by the optical encoder assembly 100.

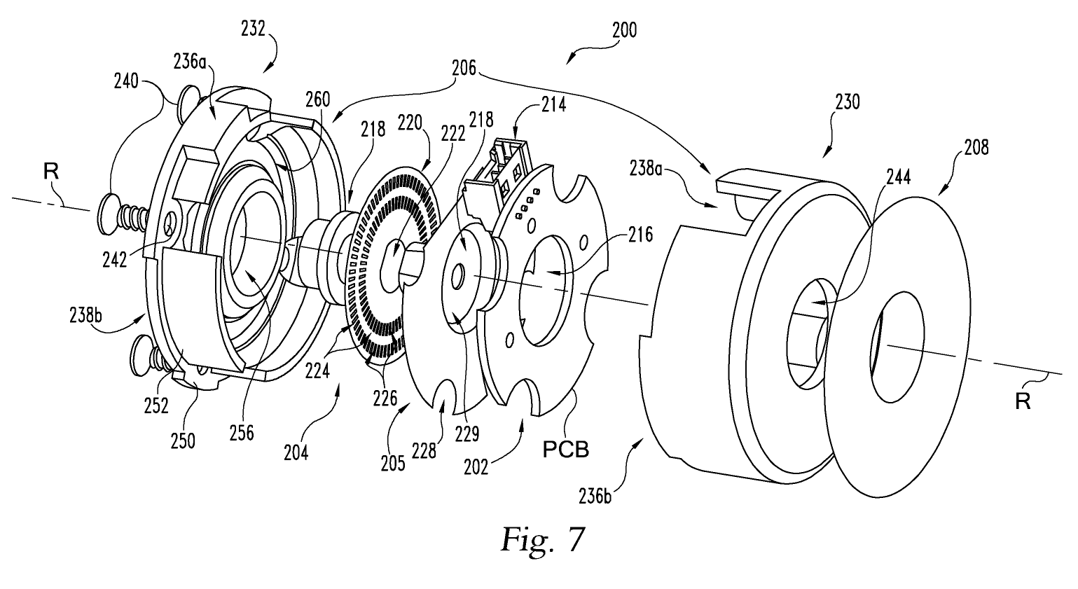

Referring to FIG. 7, shown therein is an optical encoder assembly 200 according to another form of the present invention. In many respects, the optical encoder assembly 200 is configured similar to that of the optical encoder assembly 100 illustrated and described above. The optical encoder assembly 200 generally includes a board member 202 having various electronic elements mounted thereto, a primary code mechanism or scale 204, and an encoder housing or enclosure 206. The optical encoder assembly 200 further includes a secondary reference plate or light masking element 205 positioned between the board member 202 and the primary code mechanism 204. The light masking element 205 is preferably mounted in a stationary position relative to the primary code mechanism 204.

The illustrated embodiment of the optical encoder assembly 200 is configured to sense the rotational position and/or the rotational movement of a control shaft or rod (not shown) about a rotational axis R. However, it should be understood that the optical encoder assembly 200 may alternatively be configured as a linear encoder configured to sense linear position and/or linear movement of a movable object along a linear travel axis. In one embodiment, the control shaft (not shown) is connected to a rotational connector or coupling element 208 such that rotation of the control shaft correspondingly rotates a stem or rod associated with the coupling element 208 about the rotational axis R. The stem/rod is in turn coupled to the code mechanism 204 to correspondingly rotate the code mechanism 204 about the rotational axis R in response to rotation of the control shaft. However, in other embodiments, the control shaft may be connected directly to the code mechanism 204.

In the illustrated embodiment, the board member 202 comprises a printed circuit board (PCB) and includes multiple light sources or emitter elements (not shown) and multiple photodetectors or light sensor elements (not shown), the details of which have been set forth above with regard to optical encoder assembly 100. The board member 202 is provided with an electrical connector 214 including a series of electrical terminals in electronic communication with the emitter element and the light sensor elements via traces or leads integrated onto the printed circuit board. The electrical connector 214 is adapted for coupling to a cable connector or a wire harness (not shown). The board member 202 is also provided with a central opening 216 arranged generally along the rotational axis R and sized to receive an end portion of a rotational coupling sleeve 218 therethrough, which is in turn operatively connected between the code mechanism 204 and the stem/rod associated with the coupling element 208. Although a specific embodiment of the board member 202 has been illustrated and described herein, it should be understood that other types and configurations of the board member 202 are also contemplated.

In the illustrated embodiment, the code mechanism 204 comprises an encoder wheel 220 which is rotationally connected to the stem/rod of the coupling element 208 via the coupling sleeve 218 such that rotation of the stem/rod about the rotational axis R correspondingly rotates the encoder wheel 220 about the rotational axis R. The encoder wheel 220 includes a central opening 222 having an irregular shape which receives a correspondingly-shaped portion of the coupling sleeve 218. In one embodiment, the central opening 222 is generally circular but includes flattened regions which are engaged with outer flattened sections of the coupling sleeve 218. Additionally, the encoder wheel 220 includes two code tracks or scales 224 extending circumferentially about the axis of rotation R and along a circumferential track or axis of travel, with each of the code tracks 224 including a series of apertures or slits 226 having select sizes/shapes and which are positioned along the code tracks 224 at select circumferential positions. However, in alternative embodiments, the encoder wheel 220 may be provided with a single code track or three or more code tracks. The code tracks 224 are radially offset from one another by a radial distance which is generally equal to a radial distance between the light sensor elements on the board member 202.

In the illustrated embodiment, the reference plate or light masking element 205 is positioned between the board member 202 and the encoder wheel 220. The light masking element 205 includes a number of cutout regions 228 positioned at select circumferential locations that are generally aligned with regions of the board member 202 that include a light emitter element and one or more light sensor elements. The light masking element 205 further includes a central opening 229 that is sized to receive an end portion of the rotational coupling sleeve 218 therethrough. Although a specific embodiment of the light masking element 205 has been illustrated and described herein, it should be understood that other types and configurations of the light masking element 205 are also contemplated. It should also be understood that the optical encoder assembly 200 need not necessarily include the light masking element 205.

In the illustrated embodiment, the encoder housing or enclosure 206 is configured as a two-piece housing including a housing base 230 and a housing cap 232. The housing cap 232 is operatively connected to the housing base 230 to provide an enclosed interior region sized to receive the board member 202, the code mechanism 204 and the light masking element 205 therein. In one embodiment, the housing cap 232 is engaged with the housing base 230 via a number of axially-extending tongues 236a that are received within corresponding recessed regions or grooves 238a defined by the housing base 230. Similarly, the housing base 230 includes a number of axially-extending tongues 236b that are received within corresponding recessed regions or grooves 238b defined by the housing cap 232. Additionally, a number of screws or fasteners 240 are provided which extend through axial openings 242 in the housing cap 232 and which are threaded into aligned support mounts in the housing base 230 to removably connect the housing cap 232 to the housing base 230. The housing base 230 and the housing cap 232 may also be provided with channels or recessed regions that are aligned with one another to define a transverse opening sized to receive the electrical connector 214 of the board member 202 therethrough to position the electrical connector 214 outside of the encoder housing 206 for connection with a cable connector or wiring harness (not shown). The housing base 230 further defines a central opening or passage 244 that is sized to receive an end portion of the rotational coupling sleeve 218 and/or an end portion of the stem/rod of the coupling element 208 therethrough.

In the illustrated embodiment, the housing cap 232 generally includes a substantially flat/planar end wall 250 and a generally cylindrical side wall 252. The end wall 250 and the cylindrical side wall 252 together define a portion of the interior region of the encoder housing 206. The housing cap 232 includes an axial recess 256 formed in the end wall 250 and positioned generally along the rotational axis R for receipt of sealed bearing and/or an end portion of the coupling sleeve 218 to maintain the coupling sleeve 218 and the encoder wheel 220 in proper alignment relative to the rotational axis R. Additionally, the end wall 250 and the side wall 252 of the housing cap 232 have inner surfaces that define collimating reflective surface features 260 which are configured to reflect light generated by and emitted from the light emitter element toward the light sensor elements, the likes of which have been discussed in detail above with regard to the collimating reflective surface features 160 associated with the optical encoder assembly 100. In the illustrated embodiment, the collimating reflective surface features 260 are formed integral with the housing cap 232. However, in other embodiments, the collimating reflective surface features 260 may be defined by an insert or a is secondary element formed separately from the housing cap 232 and subsequently attached to or assembled with the housing cap 232. As should be appreciated, the particular geometric configuration and surface profile of the collimating reflective surface features 260 may be varied to reflect, direct and concentrate light in multiple directions and along multiple axes to accommodate for the particular configuration and setup of the optical encoder assembly 200. It should also be appreciated that the optical encoder assembly 200 may operate in a manner similar to that of the optical encoder assembly 100 illustrated and described above.

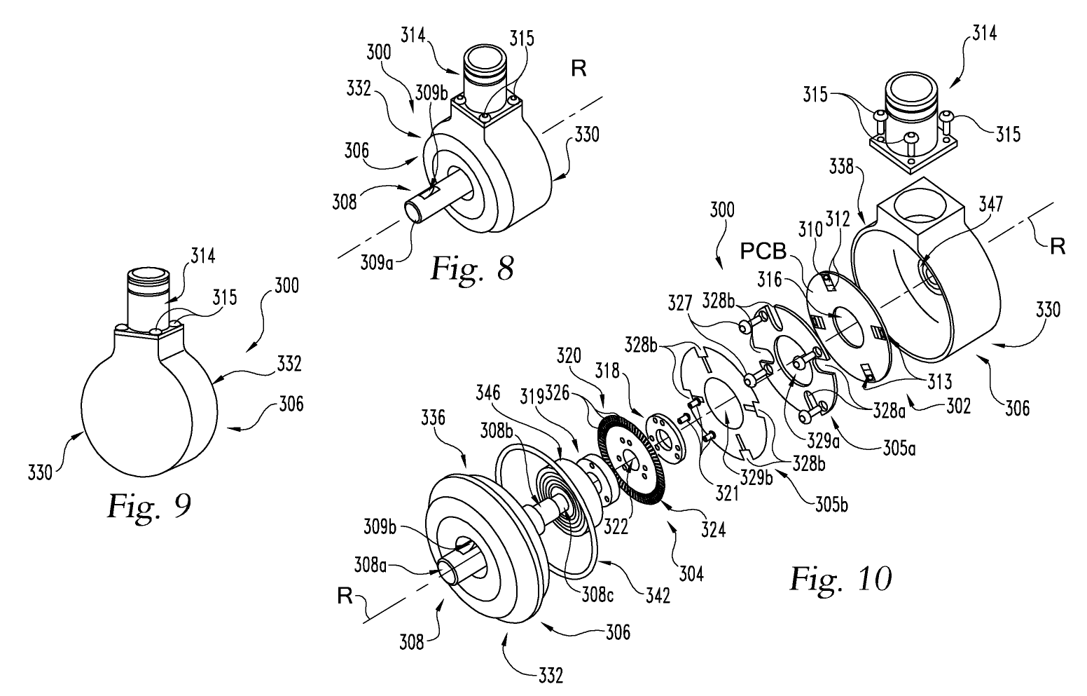

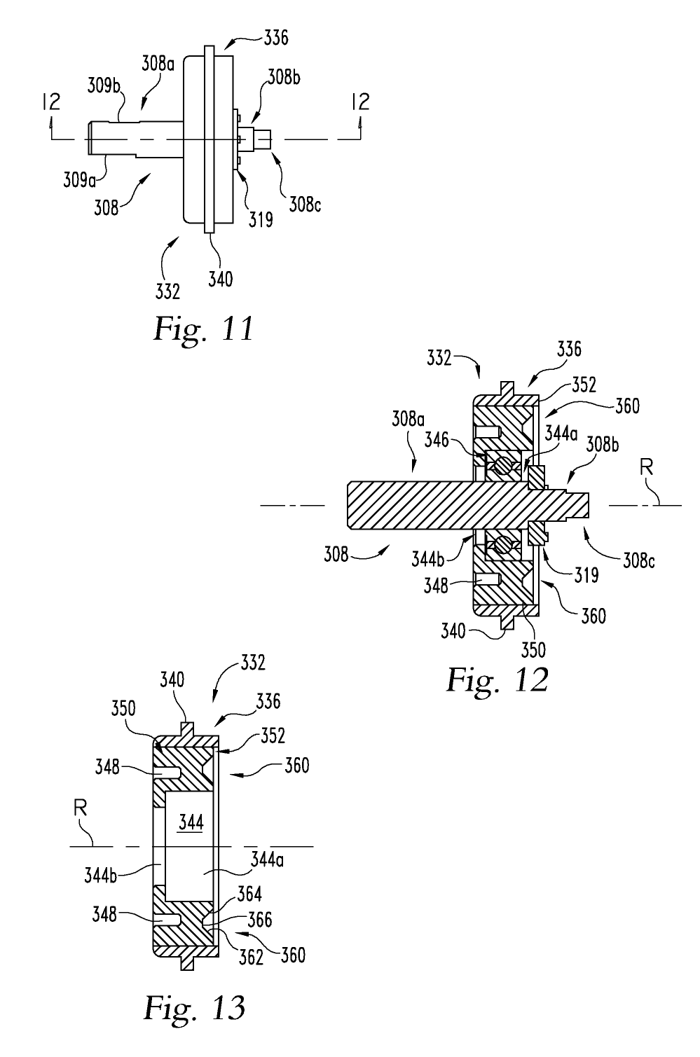

Referring to FIGS. 8-13, shown therein is an optical encoder assembly 300 according to a further form of the present invention. In many respects, the optical encoder assembly 300 is configured similar to that of the optical encoder assemblies 100 and 200 illustrated and described above. The optical encoder assembly 300 generally includes a board member 302 having various electronic elements mounted thereto, a primary code mechanism or scale 304, secondary reference plates or light masking elements 305a, 305b, and an encoder housing or enclosure 306. The light masking elements 305a, 305b are positioned between the board member 302 and the primary code mechanism 304, and are preferably mounted in a stationary position relative to the primary code mechanism 304.

The illustrated embodiment of the optical encoder assembly 300 is configured to sense the rotational position and/or rotational movement of a control shaft or rod (not shown) about a rotational axis R. However, it should be understood that the optical encoder assembly 300 may alternatively be configured as a linear encoder configured to sense linear position and/or linear movement of a movable object along a linear travel axis. In one embodiment, the control shaft (not shown) is associated with a rotational connector or coupling shaft 308 such that rotation of the control shaft correspondingly rotates the coupling shaft 308 about the rotational axis R. In the illustrated embodiment, the coupling shaft 308 includes a primary body portion 308a, an intermediate portion 308b, and a distal end portion 308c. The primary body portion 308a includes a proximal portion that is provided with a flattened region 309a for engagement by a bearing mounting pin or set screw (not shown) and a woodruff keyway 309b sized to receive a woodruff key (not shown) to facilitate rotational engagement of the coupling shaft 308 with the control shaft or another intermediate coupling member. The coupling shaft 308 is in turn coupled to the code mechanism 304 to correspondingly rotate the code mechanism 304 about the rotational axis R in response to rotation of the control shaft. However, in other embodiments, the control shaft may be connected directly to the code mechanism 304.

In the illustrated embodiment, the board member 302 comprises a printed circuit board (PCB) and includes multiple light sources or light emitter elements 310 and multiple photodetectors or light sensor elements 312. In the illustrated embodiment, the board member 302 includes four emitter/sensor locations 313 positioned at uniform circumferential locations about the board member 302, with each emitter/sensor location 313 including a single light emitter element 310 and a pair of light sensor elements 312. However, it should be understood that the board member 302 may include any number of emitter/sensor locations 313, and that each emitter/sensor location 313 may be provided with two or more light emitter elements 310 and/or a single light sensor elements 312 or three or more light sensor elements 312. The board member 302 is electrically coupled to an electrical connector 314 including a series of electrical terminals in electronic communication with the emitter elements and the light sensor elements. The electrical connector 314 is adapted for coupling to a cable connector or wire harness (not shown). In the illustrated embodiment, the electrical connector 314 is mounted to the encoder housing 306 via a number of screws or fasteners 315. The board member 302 is also provided with a central opening 316 that is sized to receive an end portion of the coupling shaft 308 therethrough. Although a specific embodiment of the board member 302 has been illustrated and described herein, it should be understood that other types and configurations of the board member 302 are also contemplated.

In the illustrated embodiment, the code mechanism 304 comprises an encoder wheel 320 which is rotationally connected to the coupling shaft 308 via a shaft ring 318 positioned on one side of the encoder wheel 320 and a shaft hub 319 positioned on the opposite side of the encoder wheel 320. The shaft hub 319 is press fit on to the intermediate portion 308b of the coupling shaft 308 (FIG. 12) and the shaft ring 318 is connected to the shaft hub 319 via a number of screws or fasteners 321 which extend through corresponding axial openings in the encoder wheel 320 and into aligned threaded openings in the shaft hub 319. The shaft hub 319 includes a series of axial projections or mounting posts (not shown) that extend through corresponding axial openings in the encoder wheel 320 and into aligned openings in the shaft ring 318 to properly locate the encoder wheel 320 relative to the shaft hub 319 and the coupling shaft 308. The encoder wheel 320 is sandwiched between the shaft ring 318 and the shaft hub 319 to rotationally couple the encoder wheel 320 to the coupling shaft 308 such that rotation of the coupling shaft 308 about the rotational axis R correspondingly rotates the encoder wheel 320 about the rotational axis R. The encoder wheel 320 includes a central opening 322 arranged generally along the rotational axis R and sized to receive the intermediate portion 308b of the coupling shaft 308 therethrough. The encoder wheel 320 also includes a number of code tracks or scales 324 extending circumferentially about the axis of rotation R and along circumferential tracks or axes of travel, with each of the code tracks 324 including a series of apertures or slits 326 having select sizes/shapes and which are positioned along the code tracks 324 at select circumferential positions. It should be understood that the encoder wheel 320 may be provided with any number of code tracks, including a single code track or two or more code tracks. The code tracks 324 are radially offset from one another by a radial distance which is generally equal to a radial distance between adjacent ones of the light sensor elements 312 on the board member 302.

In the illustrated embodiment of the invention, the light masking elements 305a, 305b are positioned between the board member 302 and the encoder wheel 320. The light masking element 305a constitutes a mask mount/isolator that is mounted to the board member 302 and to the encoder housing 306 via a number of screws or fasteners 327. The light masking element 305b constitutes a light mask or reference plate that is mounted to the mask mount/isolator 305a via a number of small machine screws or mounting pins (not shown). The mask mount/isolator 305a and the light mask 305b each include a number of cutout regions or apertures 328a and 328b, respectively, that are positioned at select circumferential locations that are generally aligned with the emitter/sensor locations 313 on the board member 302. The mask mount/isolator 305a and the light mask 305b respectively include a central opening 329a and 329b that are sized to receive the shaft ring 318 to maintain the mask mount/isolator 305a and the light mask 305b at the correct position relative to the board member 302, the coupling shaft 308 and the encoder wheel 320. Although specific embodiments of the mask mount/isolator 305a and the light mask 305b have been illustrated and described herein, it should be understood that other types and configurations of these masking elements are also contemplated. It should also be understood that the optical encoder assembly 300 need not necessarily include the mask mount/isolator 305a and/or the light mask 305b.

In the illustrated embodiment of the invention, the encoder housing or enclosure 306 is configured as a two-piece housing including a housing base 330 and a housing cap 332. The housing cap 332 is operatively connected to the housing base 330 to provide an enclosed interior region sized to receive the board member 302, the code mechanism 304 and the light masking elements 305a, 305b therein. In one embodiment, the housing cap 332 includes an externally threaded region 336 that is threadingly engaged within an internally threaded region 338 of the housing base 330 to removably connect the housing cap 332 to the housing base 330. The housing cap 332 is also provided with an annular flange 340 which provides an annular shoulder for receipt of an O-ring seal 342 (FIG. 10) that is engaged with an axially-facing end surface of the housing base 330 to provide a fluid-tight seal between the housing cap 332 and the housing base 330. The housing cap 332 further includes an axial passage 344 (FIG. 13) extending therethrough, with a first portion 344a of the axial passage 344 containing a sealed bearing 346 which rotatably supports the main body portion 308b of the coupling shaft 308. The distal end portion 308c of the coupling shaft 308 is rotatably supported in a sealed bearing 347 mounted within the housing base 330. A second portion 344b of the axial passage 344 is sized to receive the main body portion 308a of the coupling shaft 308 therethrough. A shaft coupling element or a lid or end cap (not shown) may be mounted to the housing cap 332 via a number of screws or fasteners engaged within axial openings 348 defined through the outer face of the housing cap 332.

As shown in FIG. 13, the housing cap 332 is generally cylindrical and includes an annular side wall 350 extending about the rotational axis R. An axially facing end surface 352 of the annular side wall 350 defines collimating reflective surface features 360 which are configured to reflect light generated by and emitted from one of the light emitter elements 310 toward the corresponding light sensor elements 312, the likes of which have been discussed in detail above with regard to the collimating reflective surface features 160 associated with the optical encoder assembly 100. In the illustrated embodiment, the collimating reflective surface features 360 are defined by a pair of generally flat/planar side surfaces 362, 364 that taper inwardly to a generally flat/planar bottom surface 366. However, as should be appreciated, the collimating reflective surface features 360 may take on other shapes and geometric configurations. In the illustrated embodiment of the invention, the collimating reflective surface features 360 are formed integral with the housing cap 332. However, in other embodiments, the collimating reflective surface features 360 may be defined by an insert or a secondary element formed separately from the housing cap 332 and subsequently attached to or assembled with the housing cap 332. As should be appreciated, the particular geometric configuration and surface profile of the collimating reflective surface features 360 may be varied to reflect and direct light in multiple directions and along multiple axes to accommodate for the particular configuration and setup of the optical encoder assembly 300. It should also be appreciated that the optical encoder assembly 300 may operate in a manner similar to that of the optical encoder assemblies 100 and 200 illustrated and described above.

While the invention has been illustrated and described in detail in the drawings and foregoing description, the same is to be considered as illustrative and not restrictive in character, it being understood that all changes and modifications that come within the spirit of the invention are desired to be protected.

What is claimed is:

1. An optical encoder assembly for sensing relative position and/or relative movement of a movable object, comprising:
at least one light emitter element;
at least one light sensor element;
at least one code member including a plurality of code elements arranged along a track extending along a plane with said light emitter element and said light sensor element positioned on a first side of said plane; and
a reflector element positioned on an opposite second side of said plane and including a reflective surface having one or more collimating reflective surface features that reflect light emitted from said light emitter element to said code elements of said code member and on to said light sensor element.

2. The optical encoder assembly of claim 1, further comprising a sensor housing;
wherein said light emitter element, said light sensor element, and said code member are contained within said sensor housing; and
wherein said reflector element defining said collimating reflective surface features comprises a portion of said sensor housing.

3. The optical encoder assembly of claim 2, wherein said collimating reflective surface features are formed integral with said sensor housing.

4. The optical encoder assembly of claim 3, wherein an end wall and a side wall of said sensor housing define said collimating reflective surface features.

5. The optical encoder assembly of claim 2, wherein said collimating reflective surface features include a series of generally flat/planar surface features, convex surface features, and concave surface features that cooperate with one another to provide an overall reflective surface profile.

6. The optical encoder assembly of claim 2, wherein said collimating reflective surface features generally include:
a first reflective surface region configured to reflect, direct and concentrate light emitted from said light emitter element generally along and substantially parallel with a first light transmission axis; and
a second reflective surface region configured to reflect, direct and concentrate light emitted from said light emitter element generally along and substantially parallel with a second light transmission axis.

7. The optical encoder assembly of claim 2, wherein said collimating reflective surface features comprise a polished interior surface of said sensor housing.

8. The optical encoder assembly of claim 2, wherein said collimating reflective surface features comprise a material coating applied to an interior surface of said sensor housing.

9. The optical encoder assembly of claim 2, wherein said collimating reflective surface features comprise one or more lenses, mirrors or other reflective elements attached to an interior surface of said sensor housing.

10. The optical encoder assembly of claim 2, wherein said sensor housing is formed of a polymeric material, and wherein said collimating reflective surface features are molded into said sensor housing.
